(19) United States
(12) Patent Application Publication
(10) Pub. No.: US 2014/0153927 A1
(43) Pub. Date: Jun. 5, 2014

(54) DETECTION OF REMOTE CONTROL FOR CONFIGURATION OF UNIVERSAL REMOTE

(71) Applicant: ECHOSTAR TECHNOLOGIES L.L.C., Englewood, CO (US)

(72) Inventor: Paul Langer, Westminster, CO (US)

(73) Assignee: ECHOSTAR TECHNOLOGIES L.L.C., Englewood, CO (US)

(21) Appl. No.: 13/706,239

(22) Filed: Dec. 5, 2012

(51) Int. Cl. G05B 19/00; H04B 10/00

(52) U.S. Cl. CPC G05B 19/00; H04B 10/00
USPC 398/106; 340/12.28

(57) ABSTRACT

A system and method for detection of a remote control for configuration of a universal remote control is provided. The system and method compare a received identifying signal from a first remote control to a database of known remote control signals and corresponding remote control programming codes. The system and method then select a corresponding remote control programming code for programming the universal remote control.

### BACKGROUND

1. Technical Field

The present disclosure relates to an apparatus and method for programming a universal remote control and, more particularly, to programming a universal remote control without the use of manual remote control programming code lookup.

2. Description of the Related Art

Devices that utilize remote controls are found nearly everywhere. A single home will often have several devices, each requiring a different remote, for example, a television, stereo, DVD player, surround sound system, and even curtains or lighting. This can often create frustration and confusion since many remote controls will look similar, and often remote controls will be placed in different areas of a home, making it difficult to find a particular remote control.

Universal remote controls have long been used to solve the problem of having a large number of different remote controls. A universal remote control can generally be used for a wide range of devices, eliminating the need for separate remotes. However, universal remote controls still present a considerable amount of frustration and confusion during the programming of a user's individual devices. A universal remote control needs to be customized to function with each of a user's particular devices, all of which will require a different remote control programming code to be programmed into the remote. Customization of a universal remote control has generally been performed by having a look up table, in which a user manually looks up their particular device model, and then inputs several possible codes which correspond to that device, testing each code to find the correct one. However, for many users, knowledge of the exact make and model of all of their devices can be cumbersome.

The problem of manual look up has been addressed partially by online databases of remote control programming codes, wherein a user looks at pictures to match their current remote, or current device. However, this still creates the problem of manual look up and entry of remote control programming codes, and still requires a user to sift through dozens or perhaps hundreds of pictures to match their device. Other attempts to alleviate the problem of manual entry have come in the form of “wizards” for remote control programming code identification. The wizard will guide the user through a series of questions in order to select the remote control programming code. These wizards may be either on the remote control, or on a user's computer, and entry of the code can be manual or through an interface such as USB. However, these wizards still do not solve the problem of requiring a user to find a code through specific knowledge of their devices. Many modern devices are complex audio/video equipment that were installed or selected by someone other than the user, making using the wizard difficult or impossible for an average user. In addition, a common audio/video system may include many devices, such as a display screen from one manufacturer, a set of speakers from another manufacturer, with a Blu-Ray, DVD and set-top box all from different manufacturers.

### BRIEF SUMMARY

In accordance with the present disclosure, programming a universal remote control is performed by transmitting identifying signals from a first remote control to a controlling device, which uses the identifying signals to determine a remote control programming code. This method for programming a universal remote control allows a user to program the universal remote control without manually searching for and selecting a programming code.

One embodiment of the invention provides a method for programming a remote control, in which a user transmits an identifying signal from a first remote control to a controlling device spaced away from the remote. The controlling device receives the identifying signal and compares the identifying signal to a database of remote control signals. The controller selects a remote control programming code from the database based on the comparison. A second remote control is then programmed with the remote control programming code.

The remote control programming code is determined by the controlling device. The controlling device includes a signal receiver that is configured to receive the identifying signal, a memory that stores the database of known programming codes, and a controller that compares the identifying signal to the database of programming codes. In some embodiments, the controlling device then selects a programming code, and transmits the code to the remote control.

In some embodiments, the user may be instructed to perform the steps to transmit the identifying signal. In one embodiment, the instructions are on a display screen. The display screen could be a stand-alone screen, such as a television or computer monitor, or could be a screen built in to the remote control programming system. In further embodiments, the instruction given to the user comprises telling the user to transmit signals to the controlling device by pressing certain buttons on a remote control, such as a power button. The instructions could also be in writing, for example with the instruction manual for the first or second remotes.

Various objects, features, aspects and advantages of the present disclosure will become more apparent from the following detailed description, along with the accompanying drawings.

### BRIEF DESCRIPTION OF THE SEVERAL VIEWS OF THE DRAWINGS

FIG. 1 is a block diagram of a universal remote control system according to one embodiment of the present disclosure.

FIG. 2 is a block diagram of a controlling device according to one embodiment.

FIG. 3 is a block diagram of a universal remote control according to one embodiment.

FIG. 4 is a universal remote control system according to one embodiment illustrating interactions between remote controls, a media device and a display.

FIG. 5 is flowchart of a controlling device's set up mode according to one embodiment.

FIG. 6 is a flowchart of the programming of a remote control programming code into a universal remote control according to one embodiment.

FIG. 7 is a media device according to one embodiment illustrating the media device downloading a database from a remote server.

FIG. 8 is a universal remote control system according to one embodiment illustrating a remote control and media device packaged together.

FIG. 9 is a universal remote control system according to one embodiment illustrating an audio output.

### DETAILED DESCRIPTION

FIG. 1 is a block diagram of a universal remote control system 20 according to one embodiment of the disclosure. The universal remote control system 20 comprises a universal remote control 22, controlling device 24 and user interface 26a user interface 26.

The universal remote control 22 is programmable and capable of controlling a number of different devices. The universal remote control 22 is programmed to control a device by using a remote control programming code 30, with each remote control programming code 30 being configured to control one of the devices. For example, to control a Model X 50″ LED Television, the universal remote control 22 may use the code number 10763 as a programming code, while a Model Y Blu-Ray Player may have the programming code number 16928. The remote control programming codes 30 each correspond to a specific set of remote control signals which are configured to control a given device. The remote control signals are specific signals that are received by a device, and instruct the device to perform a certain function. For example, when a power button is pressed in a remote, the device that is controlled by that remote receives the signal that has been transmitted from the remote, and interprets that signal to toggle the power of the device. Each device, and original remote, has a unique set of signals that are used to perform the various functions of the device. Some devices may have the same or similar control signals, for example, the channel up signal of a first device will also be the channel up signal of a second device. However, the devices will also have some unique signals, for example, the channel down signals will not be the same. As another example, one might be a display and another an audio amplifier and thus have unique signals for unique functions. Once the universal remote control 22 has been programmed with a certain remote control programming code 30, it will be capable of transmitting signals that the device will recognize, in order to control the device.

The controlling device 24 is used as the processing and comparing unit of the universal remote control system 20. The controlling device 24 receives an identifying signal 28 from a first remote control 34 and compares the identifying signal 28 to a database of known remote control signals. The identifying signal 28 is one of the remote control signals discussed above and it is compared to the remote control signals that are stored in the database to find the programming code 30 for devices that this universal remote control 22 can control. Each programming code 30 stored in the database has a number of corresponding identifying signals 28 by which it is identified. The controlling device 24 matches the identifying signal to any remote control signals in its database that are the same for the requested function to locate the corresponding programming code 30 for the devices it can control. For example, the user may press the power on/off button, after which the controlling device 24 compares the received identifying signal 28 to all remote control signals that function as a power signal and matches the identifying signal 28 to those that have the same power signal. The controlling device 24 then selects the remote control programming code 30 for a device that uses this same identifying signal 28 for power on/off function. This remote control programming code 30 is used to program the universal remote control 22, enabling the universal remote control 22 to control the device and thus controlled by the first remote control 34.

In some embodiments, the universal remote control 22 is paired with the controlling device 24. In these embodiments, the universal remote control 22 and controlling device 24 may be manufactured in order to natively be paired with one another, with the controlling device 24 inherently being able to receive the signals of the universal remote control 22. However, in another embodiment, the universal remote control 22 may be a separately manufactured and purchased universal remote control 22, and would not be inherently paired with the controlling device 24. In this embodiment, the controlling device 24 would be a stand-alone unit, capable of programming any number of different universal remote controls 22.

The controlling device 24 may also control the user interface 26, outputting various commands to a user through an output 36. In some embodiments, the output 36 displays instructions from the controlling device 24 to the user. The user interface 26 is one way in which the remote control system 20 interacts with the user. The user interface 26 will instruct a user to transmit the various identifying signals 28, but may also interact with the user in other ways, such as requesting confirmation for actions, or informing the user of certain processes or selections. In one embodiment, the user interface 26 may instruct a user to press a selected button, such as a power button, volume increase button or some other button or sequence of buttons. The controlling device will therefore be expecting to see a particular identifying signal 28 corresponding to the button press and can then search the database to find the programming code 30 for the device which that remote controls. Alternatively, the written instructions with a universal remote control 22 can tell a user to press a particular button or sequence of buttons so the controlling device 24 can locate the programming code 30 from the identifying signal 28 output by that first remote control 34.

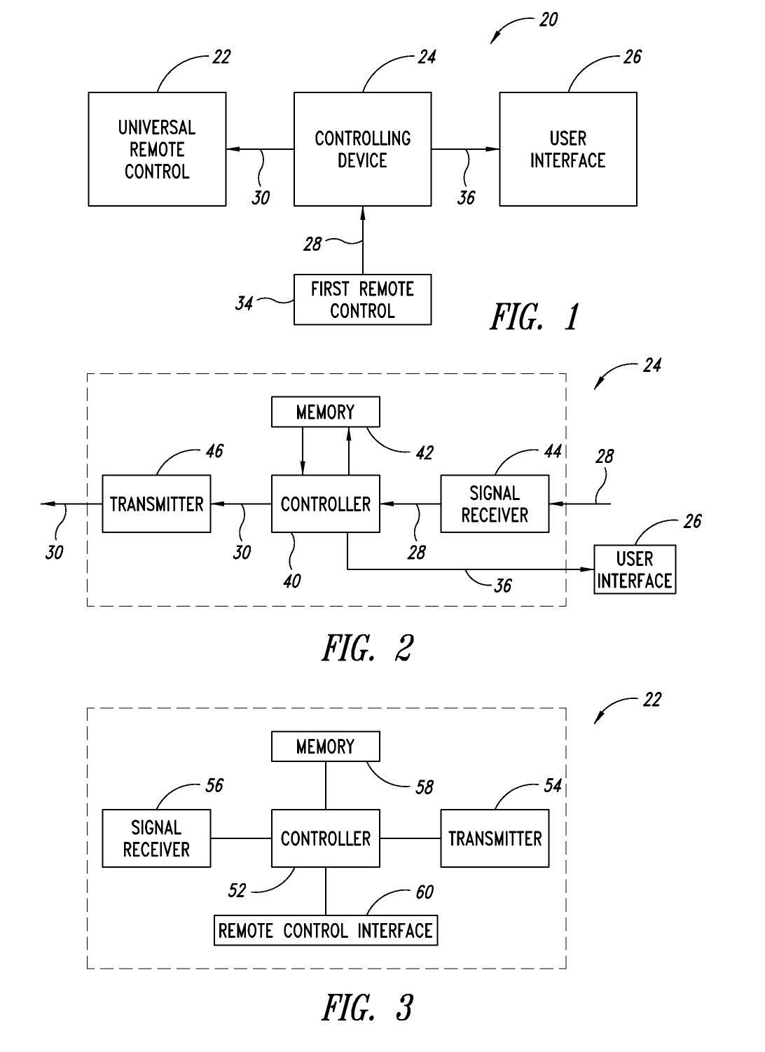

FIG. 2 shows a block diagram of some components of the controlling device 24. The controlling device 24 comprises a first controller 40, first memory 42, first signal receiver 44 and, optionally, a first transmitter 46.

The first controller 40 is usually a microprocessor, but may also be any other controller capable of comparison and read/write functions. The first controller 40 is coupled to the first memory 42, the user interface 26 and the first signal receiver 44. In one embodiment, the controller may also be coupled to the first transmitter 46 which is configured to communicate with the universal remote control 22. The first signal receiver 44 receives the identifying signal 28 from the first remote control 34. The first controller 40 then receives the identifying signal 28 from the first signal receiver 44, and uses a compare function to compare the identifying signal 28 to the remote control signals stored in the database which is stored in the first memory 42. The first controller 40 also performs the various read/write functions, and other processing functions for the controlling device 24.

In some embodiments, the first signal receiver 44 is configured to receive infrared signals, radio frequency signals, or both. The first remote control 34 can be a remote control to any number of devices, such as a television, DVD player, cable or satellite set-top box, stereo equipment, lighting or other devices. The signal receiver may also be configured to receive signals of a Wi-Fi or Bluetooth type to accommodate the wide range of possibilities for the devices. The first controller 40 then receives the identifying signal 28 from the first signal receiver 44 and compares the identifying signal 28 to the database of known remote control signals as described above.

The memory 42 stores the database for a comparison as described above. The memory 42 could store the database permanently, with memory 42 comprising a non-volatile memory, such as a hard-disk drive or Flash memory. In such an embodiment, the database may be periodically updated through an internet connection, cable or satellite connection, or a connection to a PC or other device. However, the memory 42 could also temporarily store the database for comparison, using a volatile memory such as DRAM, SRAM or other RAM and downloading the database from a remote location when requested.

The user interface 26 is preferably a display 50 to give instruction to the user. The display 50 will instruct a user to transmit identifying signals 28 from the first remote control 34, and may also relay any other information or requests to the user. For example, the display 50 might instruct a user to press the power button of the first remote control 34, or ask a user to confirm that the universal remote control 22 has been properly configured to control a device after being programmed with a selected remote control programming code 30.

FIG. 3 shows a block diagram of one embodiment of the universal remote control 22. The universal remote control 22 comprises a second controller 52 coupled to a second transmitter 54, a second memory 58, a remote control interface 60, and optionally, a second signal receiver 56.

The second transmitter 54 transmits signals to the various devices that the universal remote control 22 has been configured. The second transmitter 54 may be configured to transmit infrared signals, radio frequency signals, or both. The transmitted signals match the remote control signals that are transmitted by the first remote control for various button pushes, and are used to control the devices with which the universal remote control 22 has been configured.

In some embodiments, the second signal receiver 56 receives signals from the first transmitter 46 of the controlling device 24. The controlling device 24 is thus able to transmit data to the universal remote control 22, such as remote control programming codes 30 or backup data if the universal remote control 22 is replaced with a new unit.

The second memory 58 is used for storing data about the universal remote control 22. Examples of such data include the various remote control programming codes 30, information about the remote control interface 60, signal transmission data, and other information as is needed for operation. The memory may be any suitable memory, such as EEPROM, Flash or other memory types.

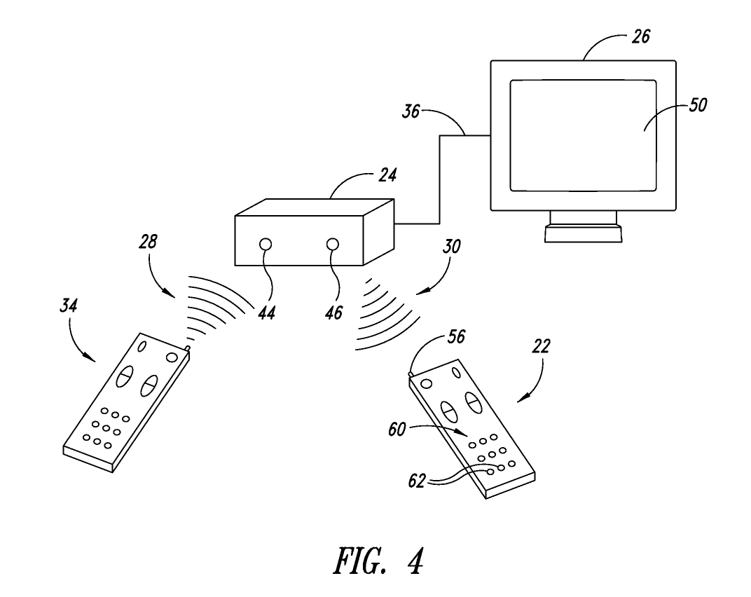

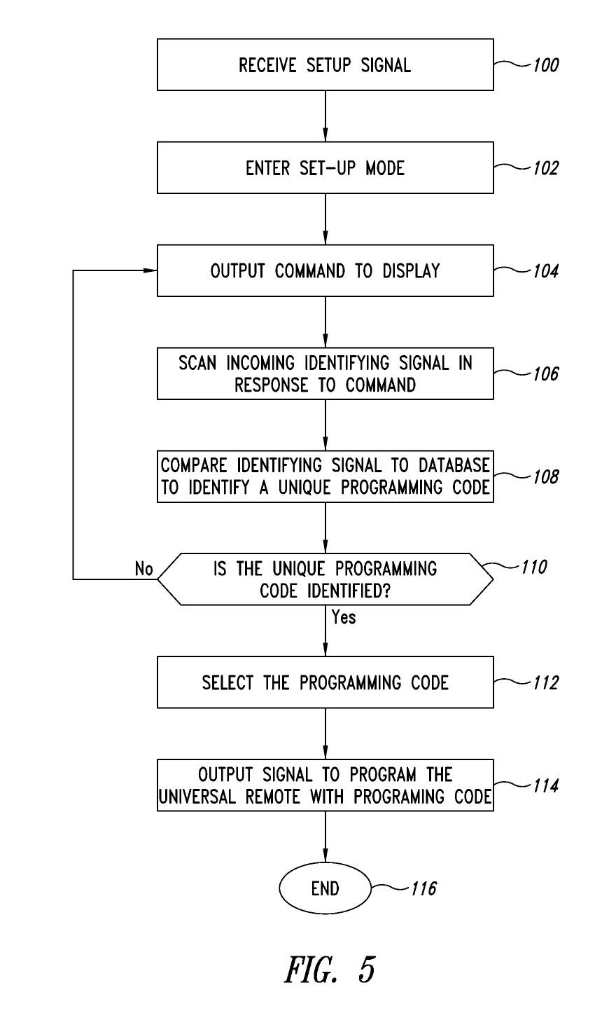

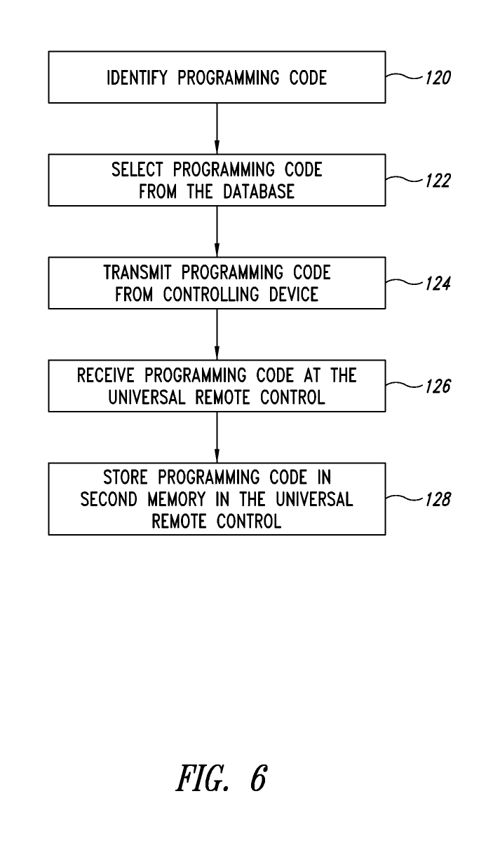

The remote control interface 60 allows a user to interact with the universal remote control 22. The remote control interface 60 generally comprises a plurality of buttons 62 as shown in FIG. 4. A user presses the buttons 62 in order to transmit signals to the various devices that the universal remote control 22 has been configured. The buttons 62 will generally include labels, such as power, volume, channel, input, and other suitable labels. The buttons 62 can be physical structures in some embodiments, or part of a touch screen display in other embodiments. On the touch screen display, the buttons 62 can be altered and moved according to the needs of the universal remote control 22.

FIG. 4 shows an embodiment of the universal remote control system 20 where the controlling device 24 is a media device, such as a cable or satellite set-top box, DVD player, Blu-Ray player or other device. In other embodiments, the controlling device 24 could be a stand-alone device, used only for remote control programming. In this embodiment, the controlling device 24 is coupled to the display 50, and uses the display 50 in order to relay instructions and other information to the user. In one embodiment, the display 50 is housed separately from the controlling device 24, and comprises a stand-alone display, such as a television or computer monitor. In other embodiments, the display 50 may be housed together with the controlling device 24 as a single unit. The device to be controlled, which might be a set-top box or television has its own remote control 34 that is included with it at the factory. It is often desired to permit the universal remote control 22 to be able to control the device as well. To do this the first remote control 34 will be used to find the programming code 30 for the device it controls and the programming code 30 will be used to program the universal remote control 22 to control the device.

The universal remote can thus control many different easily, without the user having to go through a number of complex button presses or look up tables. It can store the programming codes for many devices in one remote so that it can control a TV, DVD, Blue ray, Set-top box, audio amplifier and other devices. As each new device is added by the user, such as buying a new DVD, his existing remote can be programmed to control this device as well. These multiple programming codes can be stored in the memory of the universal remote. In addition, the system can transmit a plurality of programming controls at the same time or different times to support a plurality of different devices.

FIG. 5 is a flowchart of a set-up mode of the controlling device 24 of FIG. 2. The controlling device 24 is in a wait state until a set-up signal is received to enter the set-up mode at 100. The set-up signal is a specific signal from the universal remote control 22 in one embodiment, transmitted upon a user input to the universal remote control 22. However, in other embodiments, the set-up signal may be any unrecognized signal that is detected by the first signal receiver 44. Entering the set-up mode when an unrecognized signal is detected will allow the controlling device 24 to enter the set up mode whenever a user introduces a new first remote control 34 to the controlling device 24. In this embodiment, the controlling device 24 may output a command to a user, requesting confirmation that the user would like to enter the set-up mode. For example, the user interface 26 may inform the user “a new device remote has been detected, would you like to program the universal remote to control this device?” The user would then either confirm or deny the request to program the universal remote control 22, entering the set up mode if the request is confirmed.

Once the controlling device 24 has entered the set-up mode at 102, the user interface 26 instructs a user at step 104 to transmit the identifying signal 28 to the controlling device 24 using the first remote control 34. When the user transmits the identifying signal 28 to the controlling device 24, the first signal receiver 44 receives the identifying signal 28 at 106, and the first controller 40 compares the identifying signal 28 to the database of known remote control signals at 108. The database is configured to have stored therein a plurality of remote control programming codes 30, each with a set of corresponding remote control signals. The first controller 40 matches the identifying signal 28 to all possible remote control programming codes 30 and determines if a unique programming code 30 has been identified, at 110. If there is more than one of the remote control programming codes 30 with the identifying signal 28, then the output will instruct the user to transmit a second identifying signal. The second identifying signal further defines the remote control programming code 30. This process continues until a single remote control programming code 30 is identified.

When the remote control programming code 30 is identified, it will be selected at 112, and output to the universal remote control 22 at 114. In one embodiment, the controlling device 24 programs the universal remote control 22 automatically. The controlling device 24 transmits the remote control programming code 30 through first transmitter 44 to the universal remote control 22, and the universal remote control 22 receives and stores the remote control programming code 30. In another embodiment, the user interface 26 instructs a user to manually program the universal remote control 22. In such an embodiment, the user interface 26 displays the remote control programming code 30 on the display 50. The user reads the remote control programming code 30 and manually enters the remote control programming code 30 into the universal remote control 22. This would allow the user to program a wide number of different universal remote controls 22, even if they have not been configured to receive signals from the controlling device 24.

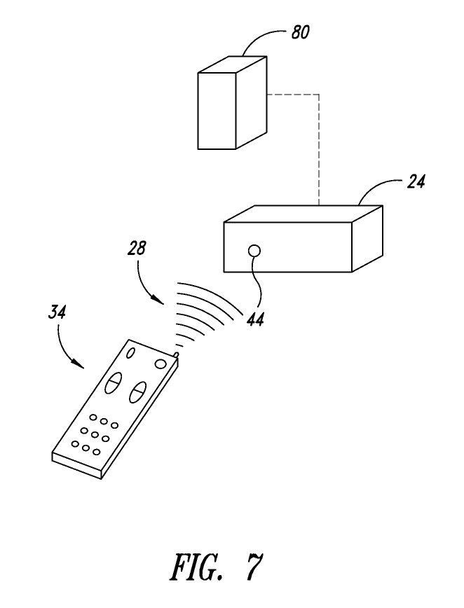

FIG. 6 is a flowchart of one embodiment of programming the universal remote control 22 with the selected remote control programming code 30. In this embodiment, the controlling device 24 selects the identified remote control programming code 30 at 120 and 122, and transmits the remote control programming code 30 via first transmitter 46 at 124. The transmitter 46 could transmit the programming code 30, and other data, through several different signal types, such as infrared, RF4CE, Wi-Fi, Bluetooth or other signal protocols. The remote control programming code 30 is received by the second signal receiver 56 of universal remote control 22 at 126. The second signal receiver 56 then transfers the remote control programming code 30 to the second memory 58 of the universal remote control 22 at 128. In other embodiments, for example if the universal remote control 22 and the controlling device 24 are housed together, the first controller 40 may transfer the remote control programming code 30 directly to the second memory 56 without using the first transmitter 46 or second signal receiver 56.

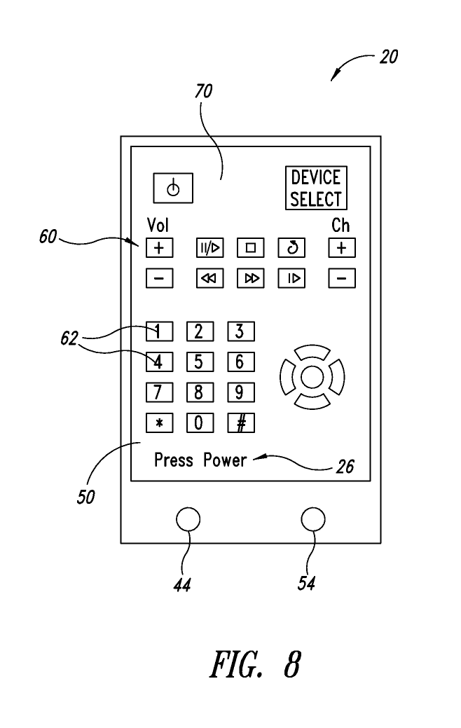

FIG. 7 shows an embodiment in which the database is downloaded to the controlling device 24 and first memory 42 through a remote server 80. The remote server 80 may be connected to the controlling device 24 through the Internet, or another suitable means such as a television's cable or satellite connection. The database will be stored on the first memory 42 upon retrieval for comparison to the identifying signal 28. It is common that new devices are sold each year. As each new device comes on the market having its own programming code and signals to control it, they are provided to a large database, such as on a server at a server farm. The database of new remotes can be downloaded periodically, such as once a month, to the controlling device 24. If the controlling device 24 receives a signal 28 from a remote 34 that it does not recognize or have stored in its database, it can query to the remote server 80 to retrieve a new database that has the new remote control identifying signal 28 and new device programming codes 30.

FIG. 8 shows an embodiment in which the display 50, controlling device 24 and universal remote control 22 are packaged in a single housing. In this embodiment, the universal remote control system 20 is a single unit. The first controller 40 and second controller 52 may be a single controller and, similarly, the first memory 42 and second memory 58 may be a single memory, or separate partitions of a single memory. For example, the universal remote control system 20 may use one controller to perform all functions of the remote control system, with all peripherals connected to the one controller. A single memory could be connected to the single controller, with all information stored therein, including the database, remote control interface data, signal data, and operating data. Additionally, the display 50 may be used as the remote control interface 60 in this embodiment, using a touch screen display 70 to interact with the user for both interfacing and instruction. This touch screen display 70 would also function as the user interface 26 of the remote control system 20, giving the user instructions and information.

In one embodiment, the universal remote control system 20 may be a stand-alone device, such a dedicated touch screen universal remote control 22. However, in other embodiments, the universal remote control system 20 may be a part of a smartphone or tablet device. For example, the universal remote control system could be a software application on an iPhone or an iPad with an accessory device that may be plugged in to the smartphone or tablet comprising the first signal receiver 44 and second transmitter 54. In this embodiment, the controller, memory, and touch screen display 70 would all be inherent in the smartphone or tablet device.

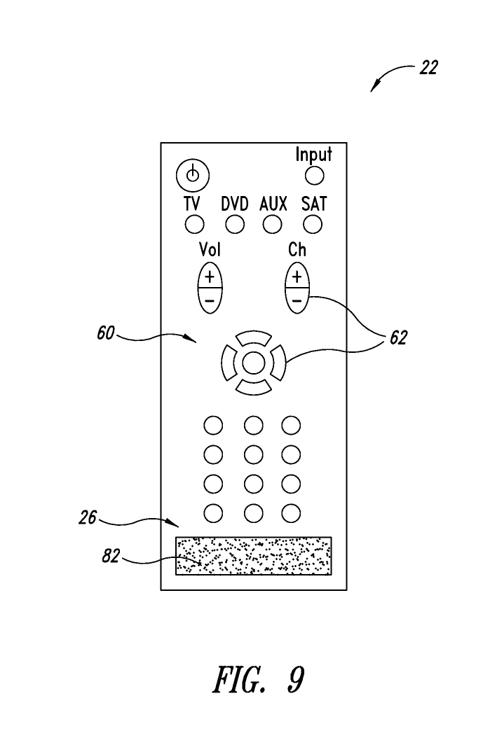

FIG. 9 shows another embodiment, wherein the user interface 26 is a speaker 82. In such an embodiment, the speaker 82 may be packaged with the controlling device 24, the universal remote control 22, or may be separate from the universal remote control system 20, such as the speakers of a television or stand-alone audio equipment. For example, the universal remote control 22 could come with a built in speaker 82 to give commands and information to the user.

In this embodiment, the speaker 82 will output a command to a user auditorily by saying the instruction out loud to press selected buttons to carry out the programming of the universal remote control 22. The use of a speaker 82 as the user interface 26 could be used by itself, or in conjunction with other forms of user interfaces, such as a display 50. In one embodiment, a user could select if they desired to have the user interface 26 to be a speaker 82, display 50, or both.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of programming a remote control, comprising:
instructing a user to transmit an identifying signal from a first remote control;
receiving the identifying signal from the first remote control;
comparing the received identifying signal to a database of remote control signals;
selecting a remote control programming code from the database based on the comparison of the received identifying signal and the database of remote control signals; and
programming a second remote control with the remote control programming code.

2. The method of claim 1, wherein instructing the user comprises outputting a command to a display.

3. The method of claim 2, comprising displaying the selected remote control programming code on the display.

4. The method of claim 3, comprising receiving a user input to program the second remote control with the displayed remote control programming code.

5. The method of claim 1, wherein the identifying signal is an infrared signal.

6. The method of claim 1, wherein the identifying signal is a radio frequency signal.

7. The method of claim 1, comprising transferring the selected remote control programming code to a memory of the second remote control.

8. The method of claim 7, comprising transmitting the selected remote control programming code to the second remote control.

9. The method of claim 1, instructing the user to successively press at least one button of the first remote control until a corresponding remote control programming code is identified.

10. The method of claim 1, comprising downloading the database from a remote server.

11. A device for programming a remote control, comprising:
at least one signal receiver configured to receive an identifying signal from a first remote control;
a memory including a database of known remote control signals and remote control programming codes; and
a controller, configured to compare the identifying signal to the database of known remote control signals, select one of the remote control programming codes based on the comparison, and transfer the selected remote control programming code to a second remote control.

12. The device of claim 11, further comprising a transmitter configured to transmit the selected remote control programming code to the second remote control.

13. The device of claim 11, further comprising a user interface coupled to the controller.

14. The device of claim 11, wherein the controller outputs a request to the user to transmit the identifying signal.

15. A system, comprising:
a controlling device including:
a first signal receiver configured to receive an identifying signal from a first remote control;
a first memory comprising a database of known remote control signals and remote control programming codes;
a first controller configured to compare the first remote control signal to the known remote control signals and select one of the remote control programming codes;
a first transmitter coupled to the first controller and configured to transmit the selected remote control programming code; and
a second remote control, including:
a second controller;
a second memory coupled to the second controller configured to store the selected remote control programming code;
a second signal receiver coupled to the second controller and configured to receive signals from the first transmitter; and
a second transmitter coupled to the second controller and configured to transmit signals.

16. The system of claim 15, wherein the controlling device is a media device.

17. The system of claim 15, wherein the selected remote control programming code is recorded on the controlling device.

18. The system of claim 15, wherein the command instructs a user to transmit a signal from the first remote control.

19. The system of claim 15, wherein the controlling device and the second remote control are packaged in a single housing.

20. The system of claim 19, wherein:
the first memory and the second memory are parts of a same memory device; and the first controller and the second controller are parts of a same controller.
